(19) United States
(12) Patent Application Publication
(10) Pub. No.: US 2017/0109586 A1
(43) Pub. Date: Apr. 20, 2017

(54) SENSITIVITY ADJUSTMENT FOR COMPUTER-VISION TRIGGERED NOTIFICATIONS

(71) Applicant: Canary Connect, Inc., New York, NY (US)

(72) Inventors: Mayank Rana, Jersey City, NJ (US); Timothy Robert Hoover, Brooklyn, NY (US); Marc P. Scoffler, Brooklyn, NY (US); JonPaul Vega, New York, NY (US)

(21) Appl. No.: 15/294,049

(22) Filed: Oct. 14, 2016

Related U.S. Application Data
(60) Provisional application No. 62/242,571, filed on Oct. 16, 2015.

(51) Int. Cl. G06K 9/00; G06T 7/20; G06T 7/00; G06N 5/02

(52) U.S. Cl. CPC G06K 9/00718; G06N 5/02; G06K 9/00771; G06T 7/20; G06T 7/0081; G06K 2009/00738; G06T 2207/10016; G06T 2207/30232

(57) ABSTRACT

A computer-based method includes classifying motion in a video file using a classifier to produce a confidence score for the video file that indicates how confident the classifier is that motion in the video file is a particular type of motion (e.g., motion by a living being). The method further includes enabling a first human user to specify (e.g., with a slider-style graphical control element), from a first user computing device, a first threshold confidence score for receiving notifications about videos. The method further includes sending a first notification of the uploaded video file if the confidence score for the video file meets or exceeds the user-specified first threshold confidence score for receiving notifications about videos. The first notification, if sent, is accessible at least from the first user computing device.

### CROSS-REFERENCE TO RELATED APPLICATION

This application claims the benefit of priority to U.S. Provisional Patent Application No. 62/242,571, entitled User Specific, Dynamic Curation of Events and Notifications Through Automated Classification and Activity Learning, which was filed on Oct. 16, 2015.

The disclosure of the prior application is incorporated by reference herein in its entirety.

### FIELD OF THE INVENTION

This disclosure relates to a monitoring system, such as a security monitoring system for example, and, more particularly, relates to adjusting the monitoring system's sensitivity for sending computer-vision triggered user notifications.

### BACKGROUND

Home security devices and systems, such as those available from Canary Connect, Inc. in New York, N.Y. generate large quantities of data surrounding home-based events, from security and activity to health and comfort. Converting this data into meaningful information that can be framed into actionable context, specific to individuals, is a largely unsolved job in the connected home space.

### SUMMARY OF THE INVENTION

In one aspect, a computer-based method includes classifying motion in a video file using a classifier to produce a confidence score for the video file that indicates how confident the classifier is that motion in the video file is a particular type of motion. The method further includes enabling a first human user to specify (e.g., with a slider-style graphical control element), from a first user computing device, a first threshold confidence score for receiving notifications about videos. The method further includes sending a first notification of the video file if the confidence score for the video file meets or exceeds the user-specified first threshold confidence score for receiving notifications about videos, where the first notification, if sent, is accessible at least from the first user computing device.

In another aspect, a computer-based system includes a monitoring device, a remote (e.g., cloud-based) computer-based processing system coupled to the monitoring device via a network, and a first user computing device coupled to the remote computer-based processing system via the network. The monitoring device is configured to create a video file showing a monitored physical location, and upload the video file to the remote computer-based processing system. The remote computer-based processing system is configured to classify the uploaded video file using a classifier to produce a confidence score indicating how confident the classifier is that motion in the uploaded video file is a particular type of motion. The first user computing device is configured to enable a first human user to specify a first threshold confidence score for receiving notifications about videos. The remote computer-based processing system is further configured to send a notification of the uploaded video file if the confidence score associated with the uploaded video file meets or exceeds the user-specified first threshold confidence score for receiving notifications about videos. The notification, if sent, is accessible from at least the first user computing device.

In yet another aspect, a non-transitory, computer-readable medium is disclosed that stores instructions executable by one or more processors to perform or facilitate the steps comprising: uploading a video file from a monitoring device to a remote computer-based processing system, classifying the uploaded video file using a classifier at the remote computer-based processing system that produces a confidence score indicating how confident the classifier is that motion in the uploaded video file corresponds to a particular class of motion, enabling a first human user to specify, from a first user computing device, a first threshold confidence score for receiving notifications about videos, and sending a first notification of the uploaded video file if the confidence score associated with the uploaded video file meets or exceeds the user-specified first threshold confidence score for receiving notifications about videos. Again, the first notification, if sent, is accessible at least from the first user computing device.

In some implementations, one or more of the following advantages are present.

For example, a security monitoring system may be provided that enables a user of the system to specify how sensitive the system should be in notifying that user of detected motion in a monitored space. In some implementations, that setting applies to every member of the user's household or business/organization. In other implementations, the security monitoring system may enable each specific user in a particular household or business/organization to specify how sensitive the system should be in notifying that specific user of any detected motion in the monitored space.

The systems disclosed herein may give users the ability to be notified of more or less of what is happening in a monitored space. Moreover, it may give users the ability to tune system sensitivity so as to minimize or eliminate false positives (e.g., where notifications are sent for videos that include no motion or that include only motion that is not of particular interest to the user). Additionally, by classifying motion of similar types (e.g., person, dog, cat, etc.), the system may enable users to choose what types of things to be notified of.

Other features and advantages will be apparent from the description and drawings, and from the claims.

### BRIEF DESCRIPTION OF THE DRAWINGS

FIG. 1 is a schematic representation of an exemplary security monitoring system.

FIG. 2 is a flowchart showing an exemplary implementation of how the system in FIG. 1 might enable human users to set or adjust the system's sensitivity for sending notifications to the user.

FIG. 3 is a screenshot showing an example of a graphical control element in the form of a slider for controlling system sensitivity to motion.

FIG. 4 is an example of a push notification that might be sent to a user computing device by the system.

FIG. 5 is an example of a screenshot that includes a timeline of system related events associated with a particular monitored location.

FIG. 6 is a flowchart showing a somewhat detailed example of one implementation of how the system processes a particular video file to determine whether to send a notification for the video file or not.

FIG. 7 is a schematic representation showing a video file and the same video file having been divided into multiple video segments, with each video segment consisting of multiple video frames.

FIG. 8 shows an exemplary screenshot that includes multiple graphical control elements in form of sliders.

FIG. 9 shows an example of a single video frame that may be collected by the monitoring device, with one bounding box to identify a region of interest.

FIG. 10 shows another example of a single video frame that may be collected by the monitoring device, with two bounding box to identify regions of interest.

FIG. 11 shows yet another example of a single video frame that may be collected by the monitoring device, with two bounding box to identify regions of interest.

FIG. 12 is a block diagram showing an example of a security monitoring device.

FIG. 13 is a perspective view showing an example of a security monitoring device.

Like reference characters refer to like elements.

### DETAILED DESCRIPTION

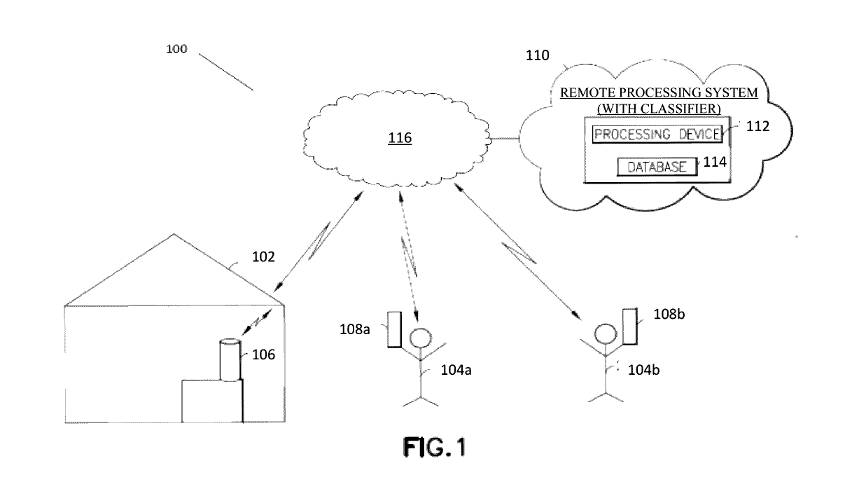

FIG. 1 is a schematic representation of an exemplary security monitoring system 100. The exemplary security monitoring system 100 is generally configured to monitor one or more characteristics associated with safety and/or security in the illustrated premises 102. In some implementations, the security monitoring system also may collect information from a location that relates to activity in that location (e.g., kids playing, etc.) and other attributes not directly related to safety/security (e.g., humidity and temperature).

The premises 102 in the illustrated example is a home and the human user's 104a, 104b of the system 100 are home owners or residents of the home. In other implementations, the premises 102 may be a commercial, or some other kind of, establishment and the human users 104a, 104b may be employees, business owners or otherwise have a commercial or other type of, interest in the monitored space (e.g., the premises 102).

The security monitoring system 100 has a security monitoring device 106 inside the monitored premises 102, user computing devices (e.g., smartphones 108a, 108b), and a remote (e.g., cloud-based) computer-based processing system 110 with one or more processors 112 and one or more memory storage devices 114. In a typical implementation, the remote processing system 110 will embody a classifier that is configured to classify motion in video files to produce confidence scores indicating how confident the classifier is that the motion in the video files is a particular type of motion (e.g., motion by a living being).

The monitoring device 106, the user computing devices 108a, 108b, and the remote processing system 110 are generally able to communicate with each other via a network (e.g., the Internet 116).

In a typical implementation, the monitoring device 106 is configured to create video files of the monitored physical location (e.g., inside premises 102), and upload at least some of those video files to the remote processing system 110. In some implementations, the monitoring device 106 only uploads a video file if it first determines that the video file contains some kind of motion.

The remote processing system 110 is configured to classify any uploaded video files according to whether they include particular types of motion. In one exemplary implementation, the remote processing system 110 is configured to classify any uploaded video files according to whether they include motion by a living being (e.g., a person, dog, cat, etc.), as opposed to motion by an inanimate object (e.g., a fan, moving images on a television screen, sunlight moving across a room, etc.). In another exemplary implementation, the remote processing system 110 is configured to separately classify each uploaded video file according to whether it include motion by a person, motion by a dog, motion by a cat, or motion by inanimate objects only.

In a typical implementation, the remote processing system 110 uses a classifier to classify the video files. The classifier may be implemented as an artificial neural network for computer vision processing. Generally speaking, an artificial neural network can be thought of as a computing system made up of a number of simple, highly interconnected processing elements, which process information by their dynamic state response to external inputs. Typically, an artificial neural network is organized in layers. Layers are made up of a number of interconnected nodes that contain an activation function. Patterns (e.g., image patterns) are generally presented to the network via an input layer, which communicates to one or more middle layers where the processing is done via a system of weighted connections. These middle layers then link to an output layer that outputs a determination (e.g., a confidence score) from the artificial neural network.

In a typical implementation, the classifier outputs a confidence score (e.g., a value between 0 and 1) indicating how confident the classifier is that motion in the uploaded video file is a particular type of motion (e.g., motion by a living being as opposed to background motion or motion by an inanimate object, such as a fan or from a television screen).

In a typical implementation, a confidence score of 0 might indicate that the classifier was not at all confident that motion in the video file was by a living being, for example, whereas a confidence score of 1 would indicate that the classifier was completely confident that motion in the video file was by a living being. Similarly, in such an implementation, a confidence score of 0.4 might indicate that the classifier was 40% confident that motion in the video file was by a living being, and a confidence score of 0.65 might indicate that the classifier was 65% confident that motion in the video file was by a living being.

Each user computing device 108a, 108b enables one or more of the human users 104a, 104b to specify a threshold confidence score for receiving notifications about videos of the monitored physical location. Generally speaking, this threshold confidence score may be thought of as the threshold for notifying the user about a particular video file. So, if a particular user has set a threshold confidence score of 0.4 and the classifier at the remote processing system 110 assigns an actual confidence score of 0.4 or higher to a particular video file, then the system 100 will send that particular user a notification (e.g., a push notification) of the video file. If, on the other hand, a particular user has set a threshold confidence score of 0.3 and the classifier at the remote processing system 110 assigns an actual confidence score of less than 0.3 to a particular video file, then the system 100 will not send that particular user a notification of the video file.

In some implementations, the system 100 enables the users to specify a threshold confidence score by presenting a screenshot (e.g., in a software application, or app, running on a user's computing device 108a, 108b) with a graphical control element that the user can manipulate to set or modify his or her own individual threshold confidence score for receiving notifications of videos. The graphical control element may be in the form of a slider that can be manipulated by the user to set or modify a particular user's threshold confidence score.

In a typical implementation, the remote processing system 110 is further configured to notify a user of an uploaded video file if the confidence score assigned to that uploaded video file meets or exceeds the threshold confidence score set by that user. The notification can be virtually any kind of electronic communication, beyond simply a passive posting to a timeline-style collection of system information available to the user within the app running on his or her user computing device 108a, 108b.

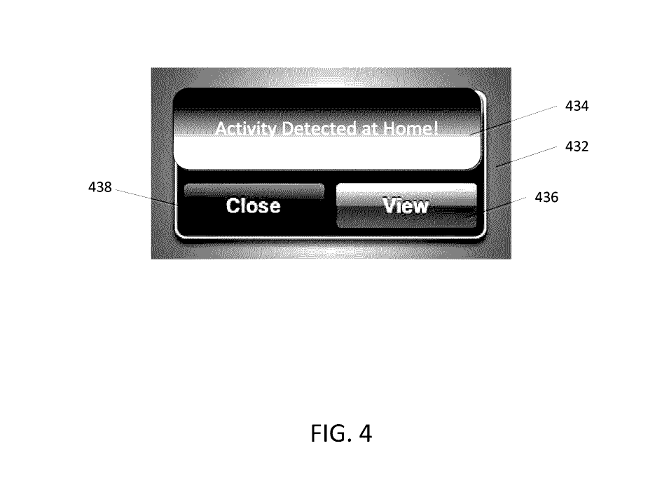

In many instances, the notification will be a push notification (e.g., a message that pops up on a user's computing device). In other instances, the notification can be a text message, an email or even a phone call. In essence, the notification typically will include a message alerting the user of the video file and the fact that the video file seems to include motion that is worthy of notifying the user. In one particular example, the notification will include a message that says, “Activity Detected at Home!” and offer the user an option to view the corresponding video file (e.g., by selecting a “view” button in the notification at the graphical user interface) or to close the notification without viewing the corresponding video file (e.g., by selecting a “close” button in the notification at the graphical user interface). An example of this kind of notification is shown in FIG. 4, which is a push notification 432, with a message portion 434, a view button 436, and a close button 438.

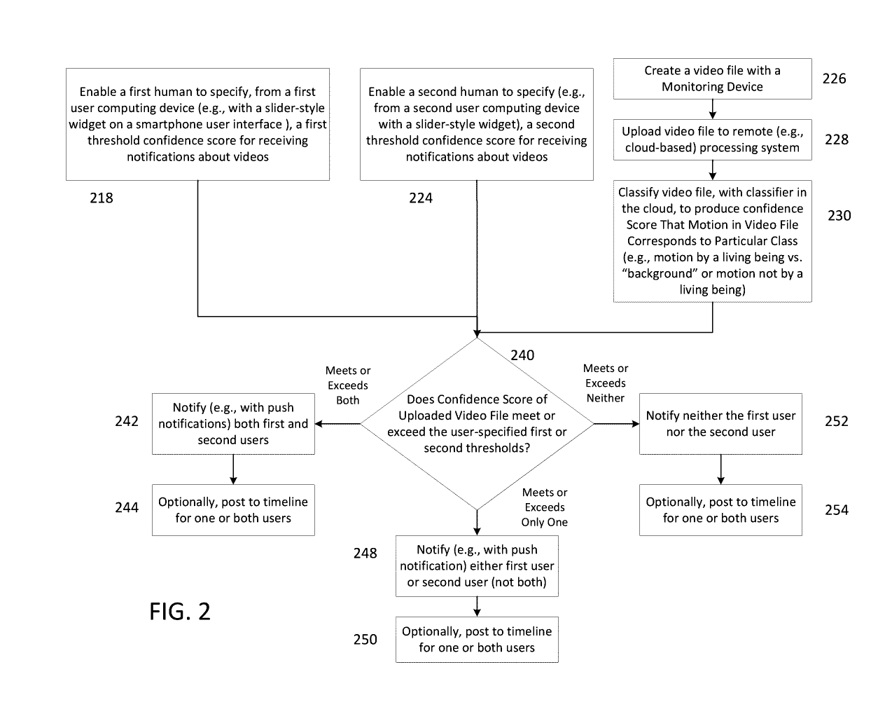

FIG. 2 is a flowchart showing an exemplary implementation of how the system 100 might enable human users (e.g., 104a, 104b) to set or adjust the system's 100 sensitivity for sending notifications to the user.

According to the illustrated flowchart, the system 100 (at 218) enables the first human user 104a to specify (e.g., from the first user computing device 108a) a first threshold confidence score for receiving notifications (e.g., push notifications) about videos collected by the monitoring device 100.

In a typical implementation, a threshold confidence score represents a minimum level of confidence that the system 100 must have that a particular video file contains a particular type of motion (e.g., motion by a living being) before the system 100 will notify the particular user. In such implementations, generally speaking, setting a user's threshold confidence score to a higher value may result in the user receiving fewer notifications, but also having a greater likelihood of missing a notification for something that the user would actually consider significant and notification-worthy. Moreover, generally speaking, setting a user's threshold confidence score to a lower value may result in the user receiving more notifications (including possibly some notifications for events that are not significant or notification-worthy), but also minimizing the likelihood of missing a notification for significant and notification-worthy events.

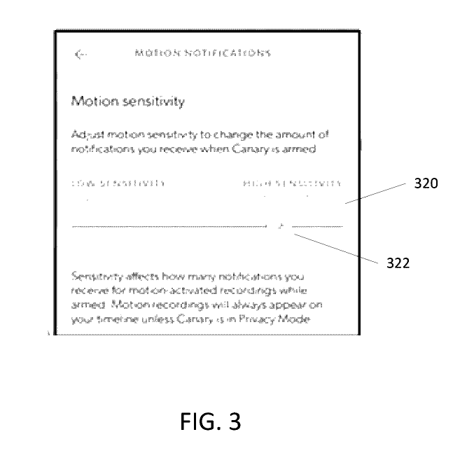

There are a variety of ways that the system 100 might enable the first user 104a to specify the first human user to specify the first threshold confidence score for receiving notifications about video files. In one exemplary implementation, the system 100 does this by presenting a graphical control element (e.g., in the form of a slider) at the user interface of the first user computing device 108a. An example of this kind of graphical control element is shown in the partial screenshot of FIG. 3.

The partial screenshot of FIG. 3 is a screenshot that might appear, for example, at the user interface of the first user computing device 108a. The screenshot includes a motion sensitivity slider 320 with an indicator 322 whose position along the slider corresponds to the system's motion sensitivity (or threshold confidence score). Generally speaking, a human user can manipulate the slider to specify the first threshold confidence score for receiving notifications about videos. In this regard, the human user can interact with the slider by moving the indicator 322 and/or by touching or clicking on a point on the slider to move the indicator 322 and thereby set the first threshold confidence score for receiving notifications about videos.

The illustrated screenshot instructs the human user, “[a]djust motion sensitivity to change the amount of notifications you receive when Canary [e.g., the security monitoring system 100] is armed.” The slider 320 itself is labeled “Low Sensitivity, Fewer Notifications” near the left end of the slider 320 and “High Sensitivity, More Notifications” near the right end of the slider 320. Generally speaking, a lower sensitivity setting on the illustrated slider 320 would correspond to a lower threshold confidence score, and a higher sensitivity setting on the illustrated slider would correspond to a higher confidence score. In this regard, the screenshot explains that, “[s]ensitivity affects how many notifications you receive for motion-activated recordings while armed. Motion recordings will always appear on your timeline unless Canary is in Privacy Mode.”

The slider is not numerically labeled in the illustrated screenshot. However, there are nine evenly-spaced marks along the length of the slider 320. In a typical implementation, setting the indicator 322 at the far left end of the slider 320 would correspond to a threshold confidence score of 0 (zero), and setting the indicator 322 at the far right end of the slider 210 would correspond to a threshold confidence score of 1 (one). Each mark along the length of the slider would correspond to an incremental change of 0.1 in the threshold confidence score. Thus, although the labeling on the slider 320 in the illustrated example seems to indicate that the slider sets “sensitivity,” not a threshold confidence score, the sensitivity setting in the slider correlates directly to a threshold confidence score setting.

Returning to FIG. 2, the system 100 (at 224) also enables a second human user 104b to specify (e.g., from the second user computing device 108b) a second threshold confidence score for receiving notifications (e.g., push notifications) about videos collected by the monitoring device 100. In a typical implementation, the system 100 enables the second human user 104b to specify the second threshold confidence score in much the same way that it enables the first human user 104a to specify the first threshold confidence score, which is discussed above in some detail.

Thus, in the illustrated implementation, the system 100 enables two different users to specify two possibly different threshold confidence scores for receiving notifications about videos collected by the system 100. If the two users set different threshold confidence scores for themselves, one of the users might receive a notification for a particular video, when the other does not receive a notification for that video. Of course, a typical system may be able to accommodate virtually any number of users (not just one or two) and that system might be configured to enable every individual user to specify his or her own threshold confidence score for receiving notifications about videos collected by the system.

According to the flowchart of FIG. 2, the monitoring device 106 (at 226) creates a video file. In this regard, the monitoring device 106 typically has a camera or imaging device that is able to record video from its surroundings (e.g., the monitored premises 102). In some implementations, the camera is operable to start recording video in response to some trigger (e.g., an indication from a motion sensor in the monitoring device 106 that motion has been sensed in the monitored physical location).

In some implementations, the monitoring device 106 has internal processing capabilities to determine, at least on a preliminary basis, whether a recorded video includes motion. In some implementation, a video file will only be uploaded (at 228) to the remote processing system 110 if the monitoring device 106 first determines that motion is present in the recorded video file.

According to the illustrated implementation, once the video file is uploaded (at 228), the motion in the video file is classified (at 230) using a classifier at the remote computer-based processing system to produce a confidence score for the video file that indicates how confident the classifier is that the motion in the video file is a particular type of motion (e.g., by a living being).

Once the users 104a, 104b (at 218 and 224) have specified their respective threshold confidence scores, and a particular video file has been created (at 226), uploaded (at 228) and assigned a confidence score (at 230), one or more processors 112 at the remote processing system 110 consider (at 240) whether the confidence score of the uploaded video file meets or exceeds one or more of the user-specified threshold confidence scores.

If the one or more processors 112 at the remote processing system 110 determine that the confidence score of the uploaded video file meets or exceeds both of the user-specified threshold confidence scores, then the system 100 (at 242) sends a notification to both the first user 104a and the second user 104b. The first user notification may be a push notification to the first user computing device 108a, and the second user notification may be a push notification to the second user computing device 108b.

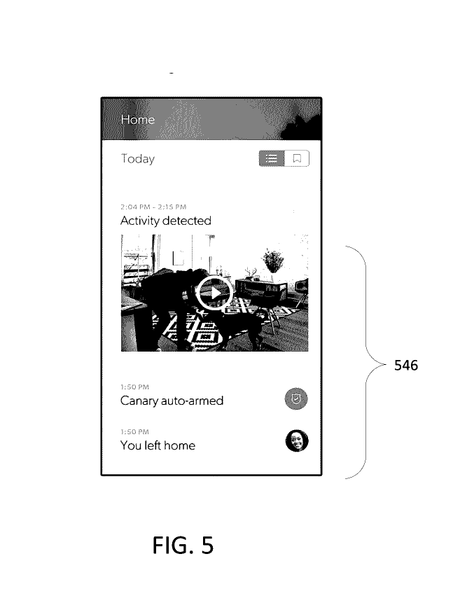

According to the illustrated example, the system 100 (at 244) may also (optionally) post the video file to timelines for system events that are accessible by the first user and/or the second user from their respective devices 108a, 108b. More particularly, in a typical implementation, the timelines, and other system data described here, may be accessible from the user computing devices via a software application (app) running on their respective user computing devices 108a, 108b, or via a web application. An example of such a screenshot with such a timeline is shown in FIG. 5, which shows a timeline 546 for “Home” and “Today” that includes three entries: a “You left home” entry at 1:50 PM, a “Canary [i.e., the system 100] auto-armed” entry also at 1:50 PM, and an “Activity Detected” entry from 2:04 PM-2:15 PM. The “Activity Detected” entry in the illustrated example includes a thumbnail of the corresponding video file with built-in play button functionality.

In a typical implementation, any notifications (e.g., a push notification, text message, email, phone call, etc.) would be a more active form of communication to the user than simply posting a message (e.g., the “Activity Detected” entry in FIG. 5) to a passive timeline in an app.

Returning again to the flowchart in FIG. 2, if (at 240) the one or more processors at the remote processing system 110 determine that the confidence score of the uploaded video file meets or exceeds only one of the user-specified threshold confidence scores (e.g., the one specified by the first user 104a, or the one specified by the second user 104b, but not both), then the system 100 (at 248) sends a notification to whichever user (104a or 104b, but not both) should get the notification. Also, in the illustrated example, the system 100 (at 250) may also (optionally) post the video file to timelines for system events that are accessible by the first user and/or the second user from their respective devices 108a, 108b.

If (at 240) the one or more processors at the remote processing system 110 determine that the confidence score of the uploaded video file meets or exceeds neither of the user-specified threshold confidence scores, then the system 100 does not send a notification to either the first user or the second user (see 252), but may (at 254) nevertheless (optionally) post the video file to timelines for system events that are accessible by the first user and/or the second user from their respective devices 108a, 108b.

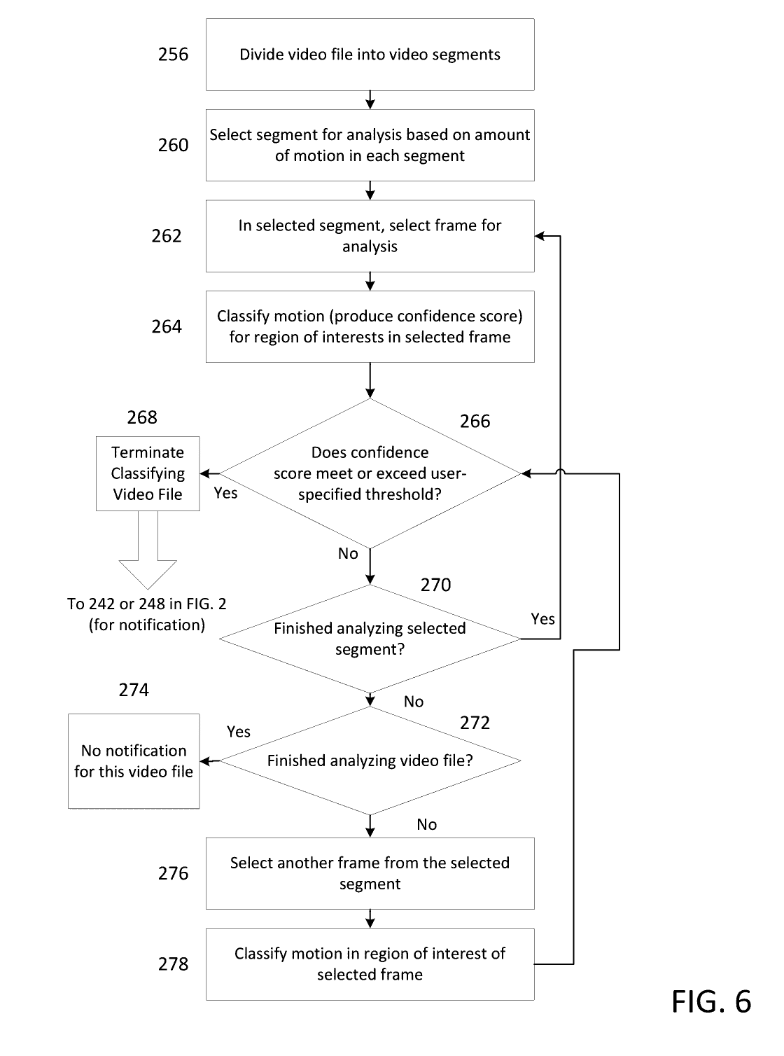

FIG. 6 is a flowchart showing a somewhat detailed example of how the system 100 might process a particular video file to determine whether to send a notification of the video file or not. In a typical implementation, the detailed steps reflected in the flowchart of FIG. 6 might be performed at the remote processing system 110 (or at the monitoring device 106 and/or the remote processing system 110) and represent a specific way of implementing the general steps of 230 and 240 shown in the flowchart of FIG. 2.

According to the illustrated method, step 1 (at 256) includes dividing the video file into multiple video segments. In a typical implementation, this is done so that, as discussed below, the video segments can be analyzed individually on a segment-by-segment basis and only as needed.

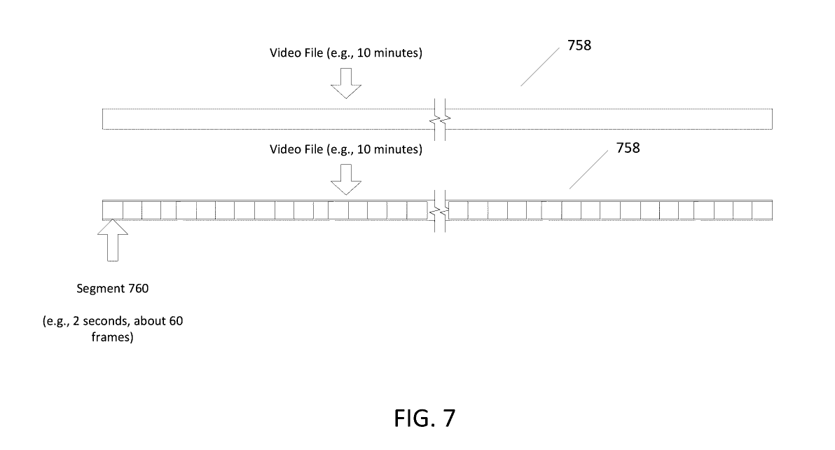

FIG. 7 is a schematic representation showing a video file 758 and the same video file 758 having been divided into multiple video segments 760, with each video segment 760 having multiple video frames. In one particular example, a video file 758 may be 10 minutes long and each video segment is 2 seconds long. In that example, the video file 758 would be divided into 300 different video segments. Moreover, in that example, each video segment may include approximately 60 video frames.

Returning again to the method represented in FIG. 6, after dividing the video file into video segments (at 256), the method includes selecting (at 260) one of those video segments for detailed analysis. In some implementations, the video segments are selected for analysis in an order that is based on how much motion is believed to be shown in each respective video segment. In those implementations, prior to selecting a video segment for detailed analysis, every one of the video segments from the video file is assigned a motion score that represents how much motion is shown in that particular video segment. Then (at 260) the video segment with the highest motion score would be selected first for detailed analysis.

Next, according to the illustrated method, (at 262) one video frame from the selected video segment is selected for analysis. In a typical implementation, analyzing a particular video segment would include analyzing fewer that all of the video frames in the video segment. For example, if a particular video segment included 60 video frames, the system 100 might only analyze every 10 frames (or 6 frames in total) in the video segment. Typically, the frames in a particular video segment would be analyzed on a frame-by-frame basis. The frames can be selected randomly or according to some particular plan.

Next, according to the illustrated method, the method includes (at 264) classifying motion represented in the frame (e.g., producing a confidence score for the frame). Typically, the motion classification in this regard focuses only on one or more regions of interest in the video frame. A region of interest is an area of pixels in the frame where it has been determined (e.g., by one or more processors at the monitoring device and/or the remote processing system) that motion is occurring.

Once the frame-specific confidence score is produced (at 264), the system 100 determines (at 266) whether the confidence score meets or exceeds a user-specified threshold confidence score for receiving notifications. If the system 100 determines (at 266) that the frame-specific confidence score meets or exceeds the user-specified threshold, then the system 100 (at 268) terminates the classifying procedure for the entire video clip and the process continues to step 242 or 248 in FIG. 2 (sending notification(s)) as appropriate.

If the system 100 determines (at 266) that the frame-specific confidence score does not meet or exceed a user-specified threshold, then the system 100 determines (at 270) whether the system 100 has analyzed the entire selected video segment or not. If the system determines (at 270) that the analysis of the selected segment is not yet complete, then the process returns to step 262, where the system 100 selects another frame from the segment for analysis.

If the system 100 determines (at 270) that the entire selected video segment has been analyzed, the system 100 determines (at 272) if the analysis is complete for the entire video file. If the analysis is complete for the entire video file (and no notifications have been issued, then the system 100 concludes (274) that no notifications are needed for the vide file. If the system 100 determines (at 270) that the entire selected video segment has not yet been analyzed, then the system 100 (at 276) selects another frame from the selected video segment, and (at 278) classifies motion (e.g., by assigning a confidence score) to motion in a region of interest in the selected frame.

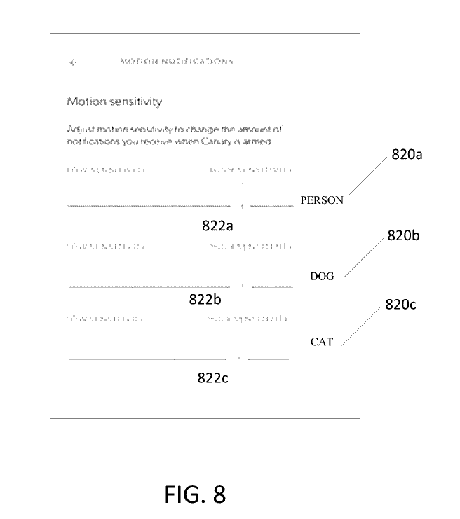

FIG. 8 shows an exemplary screenshot that includes multiple sliders 820a, 820b, 820c, each of which has its own slidable indicator 822a, 822b, 822c. The first slider 820a is labeled “Person,” the second slider 820b is labeled “Dog,” and the third slider 820c is labeled “Cat.” In a typical implementation, the first slider 820a can be manipulated to adjust the system's sensitivity (or threshold confidence score) for notifications that a video file includes motion by a person. Similarly, in a typical implementation, the second slider 820b can be manipulated to adjust the system's sensitivity (or threshold confidence score) for notifications that a video file includes motion by a dog. Likewise, in a typical implementation, the third slider 820c can be manipulated to adjust the system's sensitivity (or threshold confidence score) for notifications that a video file includes motion by a cat. Thus, a particularly user (e.g., a pet owner) may set the sliders so that the system 100 is very sensitive to (and, therefore, easily sends notification for) motion by a person, but not at all sensitive to (and, therefore, resists sending notifications for) motion by a cat or dog. Other categories (beyond simply person, dog and cat) for sliders are possible as well.

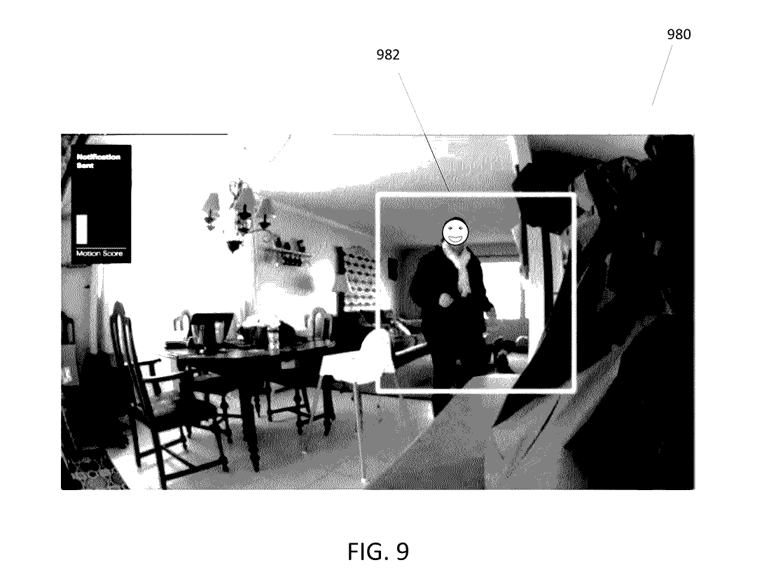

FIG. 9 shows an example of a single video frame 980 that may be collected by the monitoring device 100. The illustrated video frame 980 has one region of interest (within bounding box 982). This region of interest roughly identifies the pixels or area of the frame where motion is happening. The motion happening in that particular region of interest is a person walking through the room.

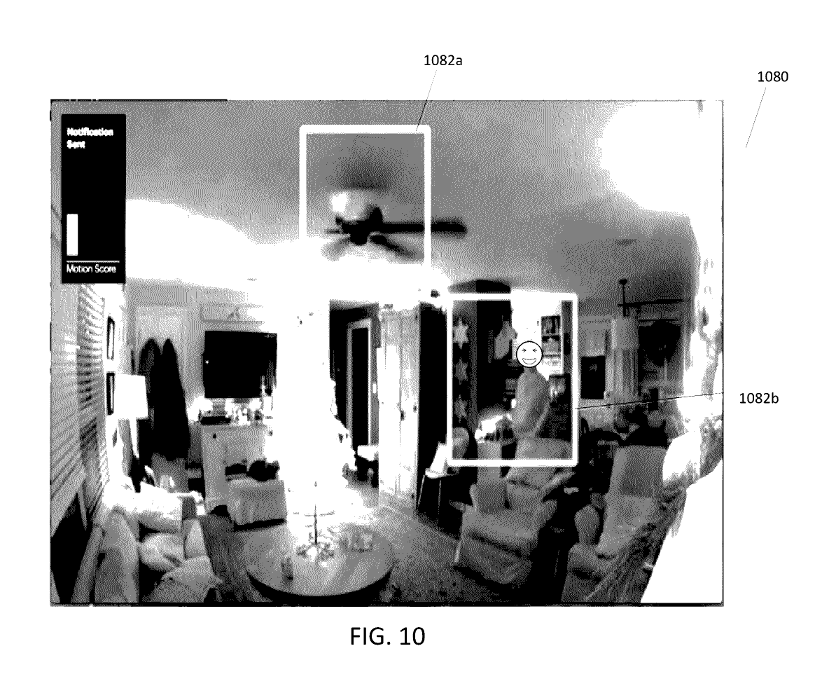

FIG. 10 shows another example of a single video frame 1080 that may be collected by the monitoring device 100. The illustrated video frame 1080 has two regions of interest (within bounding boxes 1082a and 1082b). These regions of interest 1082a, 1082b roughly identify the pixels or areas of the frame where motion is happening. The motion happening in the region of interest defined by bounding box 1082a is a fan spinning, and the motion happening in the region of interest defined by bounding box 1082b is a person walking through the space.

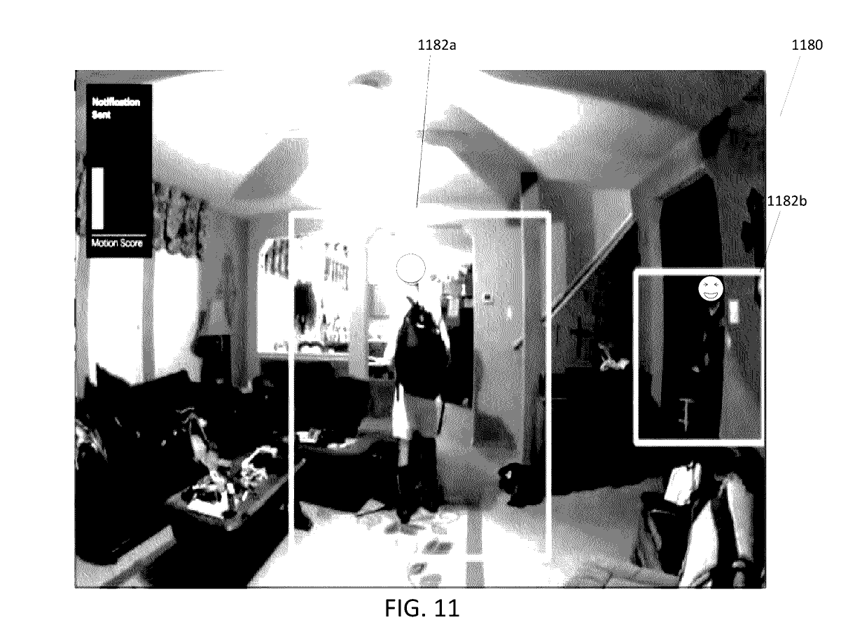

FIG. 11 shows yet another example of a single video frame 1180 that may be collected by the monitoring device 100. The illustrated video frame 1180 has two regions of interest (within bounding boxes 1182a and 1182b). These regions of interest 1182a, 1182b roughly identify the pixels or areas of the frame where motion is happening. The motion happening in the region of interest defined by bounding box 1182a is a person moving, and the motion happening in the region of interest defined by bounding box 1182b is a person entering the room.

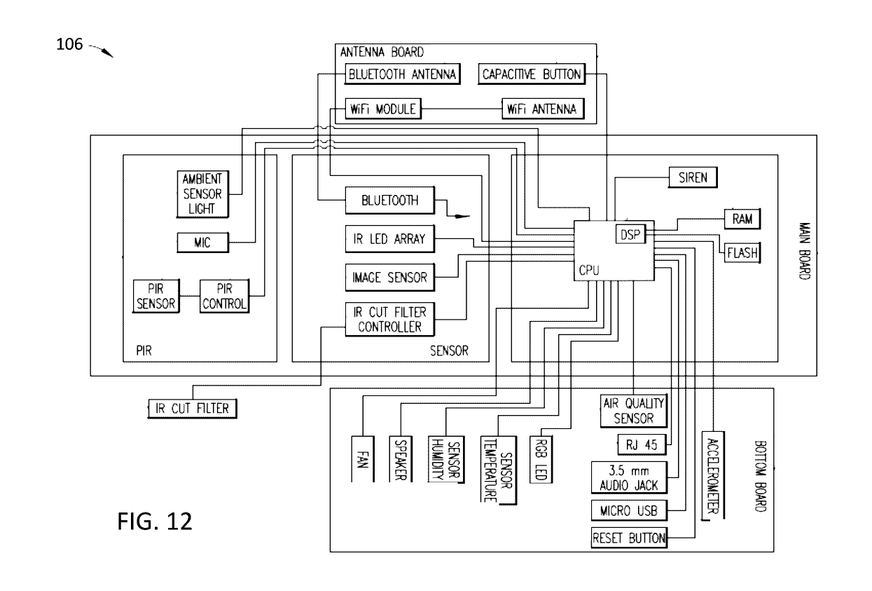

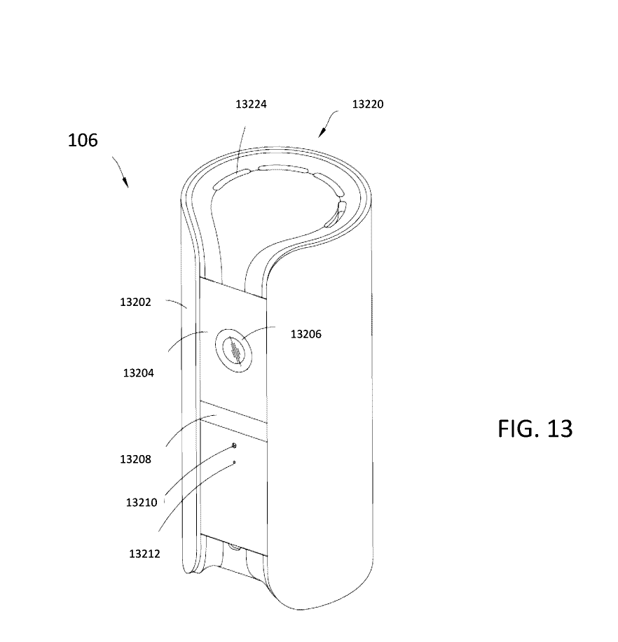

The monitoring device 106 can be virtually any kind of device that is capable of creating video files, perform some degree of processing, and communicating over a network. In some implementations, the monitoring device is much more than that. For example, in some implementations, the monitoring device may be as shown in FIGS. 12 and 13.

FIG. 12 is a block diagram showing an example of a monitoring/security device 106. In this example, the device 106 has a main printed circuit board (“PCB”), a bottom printed circuit board, and an antenna printed circuit board. A processing device, such as a central processing unit (“CPU”), is mounted to the main PCB. The processing device may include a digital signal processor (“DSP”). The CPU may be a digital signal processor. The processing device may be generally configured to perform or facilitate any of the processing functionalities described herein that may be attributable to the monitoring device 106.

An image sensor of a camera (for creating the video files), an infrared light emitting diode (“IR LED”) array, an IR cut filter control mechanism (for an IR cut filter), and a Bluetooth chip are mounted to a sensor portion of the main board, and provide input to and/or receive input from the processing device. The main board also includes a passive IR (“PIR”) portion. Mounted to the passive IR portion is a PIR sensor, a PIR controller, such as a microcontroller, a microphone, and an ambient light sensor. Memory, such as random access memory (“RAM”) and flash memory may also be mounted to the main board. A siren may also be mounted to the main board.

A humidity sensor, a temperature sensor (which may comprise a combined humidity/temperature sensor), an accelerometer, and an air quality sensor, are mounted to the bottom board. A speaker, a red/green/blue (“RGB”) LED, an RJ45 or other such Ethernet port, a 3.5 mm audio jack, a micro USB port, and a reset button are also mounted to the bottom board. A fan may optionally be provided. A Bluetooth antenna, a WiFi module, a WiFi antenna, and a capacitive button are mounted to the antenna board.

FIG. 13 is a perspective view of an exemplary monitoring device 106.

The device 106 has an outer housing 13202 and a front plate 13204. In this example, the front plate 13204 h a first window 13206, which is in front of the image sensor 1260. A second window 13208, which is rectangular in this example, is in front of the infrared LED array 1262. An opening 13210 is in front of the ambient light detector 1280, and an opening 13212 is in front of the microphone 1276. The front plate 13204 may comprise black acrylic plastic, for example. The black plastic acrylic plate 13204 in this example is transparent to near IR greater than 800 nm. The top 13220 of the device 106 is also shown. The top 13220 includes outlet vents 13224 through the top to allow for air flow out of the device 106.

A number of embodiments of the invention have been described. Nevertheless, it will be understood that various modifications may be made without departing from the spirit and scope of the invention.

For example, the system described herein is a security system and the device described herein is a security monitoring system. However, this need not be the case. Indeed, the device can be virtually any kind of device (e.g., one that monitors or collects data) that communicates over a network connection to some remote destination (e.g., a server, cloud-based resource, or user device), and that may (optionally) include some processing capabilities.

The system can include any number of monitoring devices associated with one monitored physical location (e.g., home, business, center, etc.), and any number (and different types) of user computer devices. Moreover, a particular security monitoring system can include any number of security monitoring devices arranged in any one of a variety of different ways to monitor a particular premises. The flowchart in FIG. 2 shows two different users (e.g., that may be from the same household) being able to set two different threshold confidence scores (e.g., settings that will disctate how sensitive the system is in notifying each specific user of a particular type of motion). In some implementations, however, only one user per household will have the ability to set a threshold confidence score, and that threshold confidence score will apply to all of the members of the household. The term household, in this regard, should be construed broadly to include virtually any kind of single monitored location (e.g., a single home, business, etc). Much of the processing described herein (e.g., classifying motion in the video files to produce confidence scores, determining if the confidence scores meet or exceed the corresponding threshold confidence scores, sending notifications as appropriate, etc.) can happen at either the remote (e.g., cloud-based) processing system or at the monitoring device itself. In some implementations, all of this processing is performed at the remote processing system. In some implementations, all of this processing is performed at the monitoring device. Moreover. in some implementations, the processing may be divided between the remote processing system and at the monitoring device.

The monitoring device can include any one or more of a variety of different types of sensors, some of which were mentioned above. In various implementations, the sensors can be or can be configured to detect any one or more of the following: light, power, temperature, RF signals, a scheduler, a clock, sound, vibration, motion, pressure, voice, proximity, occupancy, location, velocity, safety, security, fire, smoke, messages, medical conditions, identification signals, humidity, barometric pressure, weight, traffic patterns, power quality, operating costs, power factor, storage capacity, distributed generation capacity, UPS capacity, battery life, inertia, glass breaking, flooding, carbon dioxide, carbon monoxide, ultrasound, infra-red, microwave, radiation, microbes, bacteria, viruses, germs, disease, poison, toxic materials, air quality, lasers, loads, load controls, etc. Any variety of sensors can be included in the device. The security monitoring device(s) may be configured to communicate images and/or video files, and/or any other type of data.

In various implementations, one or more of the devices and system components disclosed herein may be configured to communicate wirelessly over a wireless communication network using any one or more of a variety of different wireless communication protocols including, but not limited to, cellular communication, ZigBee, REDLINK™, Bluetooth, Wi-Fi, IrDA, dedicated short range communication (DSRC), EnOcean, and/or any other suitable common or proprietary wireless protocol.

In some implementations, certain functionalities described herein may be provided by a downloadable software application (i.e., an app). The app may, for example, implement or facilitate one or more (or all) of the functionalities described herein. Alternatively, or additionally, some of the functionalities disclosed herein may be accessed through a website.

In various embodiments, the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control the operation of, one or more data processing apparatuses (e.g., processors). Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to include a propagated signal, a computer storage medium may be a source or destination of computer program instructions encoded in an artificially generated propagated signal. The computer storage medium can also be, or be included in, one or more separate physical components or media, for example, multiple CDs, computer disks, and/or other storage devices.

Some of the operations described in this specification can be implemented as operations performed by a data processing apparatus (e.g., a processor) on data stored on one or more computer-readable storage devices or received from other sources. The term “processor” (and the like) encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and described herein as occurring in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, some of the concepts disclosed herein can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The functionalities associated with the system disclosed herein can be accessed from smartphones, and virtually any kind of web-enabled electronic computer device, including, for example, laptops and/or tablets.

Any storage medium (e.g., in the security monitoring device(s), the remote processing system, etc.) can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Additionally, the disclosure herein focuses on motion. However, some or all of the concepts herein may be adapted to applications that involve other focuses (e.g., sound, temperature, etc.).

Other implementations are within the scope of the claims.

What is claimed is:

1. A computer-based method comprising:
classifying motion in a video file using a classifier to produce a confidence score for the video file that indicates how confident the classifier is that motion in the video file is a particular type of motion;
enabling a first human user to specify, from a first user computing device, a first threshold confidence score for receiving notifications about videos;
sending a first notification of the video file if the confidence score for the video file meets or exceeds the user-specified first threshold confidence score for receiving notifications about videos,
wherein the first notification, if sent, is accessible at least from the first user computing device.

2. The computer-based method of claim 1, further comprising not sending the first notification if the confidence score for the video file does not meet or exceed the user-specified first threshold confidence score for receiving notifications about videos.

3. The computer-based method of claim 1, wherein the first notification is communication selected from the group consisting of: a push notification, a text message, a phone call, and an email.

4. The computer-based method of claim 3, wherein the first notification includes a copy of the video file or a link to access the video file from the first user computing device.

5. The computer-based method of claim 3, further comprising:
posting the video clip to a timeline whether or not the first notification is sent,
wherein the timeline includes a collection of video files collected by the monitoring device and/or other events associated with the location of the monitoring device, and
wherein the timeline is accessible from the first user computing device.

6. The computer-based method of claim 1, wherein enabling the first human user to specify the first threshold confidence score for receiving notifications about videos comprises:
presenting a graphical control element at a graphical user interface of the first user computing device,
wherein the graphical control element is configured to be manipulated by the first human user so that the first human user can thereby specify the first threshold confidence score for receiving notifications about videos.

7. The computer-based method of claim 6, wherein the graphical control element appears as a slider on the graphical user interface, and
wherein the first human user can interact with the slider by moving an indicator and/or by touching or clicking on a point on the slider to set the first threshold confidence score for receiving notifications about videos.

8. The computer-based method of claim 1, wherein the particular type of motion is motion by a living being, and the confidence score indicates how confident the classifier is that the motion in the video file is motion by a living being.

9. The computer-based method of claim 1, wherein classifying the motion in the video file comprises:
dividing the video file into a plurality of video segments;
assigning a motion score to each respective one of the video segments, wherein respective each motion score represents an amount of motion in the associated video segment; and
analyzing one or more of the video segments in an order based on the assigned motion scores.

10. The computer-based method of claim 9, wherein analyzing each of the video segments comprises:
selecting fewer than all of the video frames from the video segment for analysis; and
analyzing only one or more of the selected video frames on a frame-by-frame basis.

11. The computer-based method of claim 10, further comprising:
ceasing to classify the motion in the video file and sending the first notification of the video file as soon as the analysis of any one of the selected video frames in any of the video segments of the video file reveals a confidence score meeting or exceeding the user-specified first threshold confidence score for receiving notifications about videos.

12. The computer-based method of claim 10, wherein the analysis of each of the selected video frames comprises:
identifying one or more regions of interest in the video frame, wherein each region of interest is a region of pixels in the video frame where motion seems to be occurring in the video file;
for each region of interest, classifying the motion that seems to be occurring to produce a region-specific confidence score.

13. The computer-based method of claim 12, further comprising:
combining the region-specific confidence scores for all of the regions of interest in the video frame to produce a frame-specific confidence score.

14. The computer-based method of claim 1, wherein classifying the video file produces multiple confidence scores for the video file, wherein each of the multiple confidence scores for the video file indicates how confident the classifier is that any of the motion in the uploaded video file is a respective one of multiple different types of motion.

15. The computer-based method of claim 14, wherein each of the multiple different types of motion is selected from the group consisting of: motion by a person, motion by a dog, motion by a cat, and motion by a non-living entity.

16. The computer-based method of claim 1, further comprising:
enabling one or more additional human users to specify, from one or more other user computing devices, one or more other threshold confidence scores for receiving notifications about videos;
sending one or more second notifications of the video file if the confidence score associated with the video file meets or exceeds any one of the other user-specified second threshold confidence scores for receiving notifications about videos, but not sending the second notification if the confidence score associated with the video file does not meet or exceed any of the other user-specified second threshold confidence score for receiving notifications about videos,
wherein the second notifications, if sent, are accessible at least from a corresponding one of the other user computing devices.

17. The computer-based method of claim 1, further comprising:
creating the video file with a monitoring device; and
uploading the video file from the monitoring device to a remote computer-based processing system prior to classifying the motion in the video file,
wherein the classifier is at the remote computer-based processing system.

18. The computer-based method of claim 1, wherein the classifier comprises an artificial neural network for computer vision processing.

19. A computer-based system comprising:
a monitoring device;
a remote computer-based processing system coupled to the monitoring device via a network; and
a first user computing device coupled to the remote computer-based processing system via the network,
wherein the monitoring device is configured to:
create a video file showing a monitored physical location; and
upload the video file to the remote computer-based processing system;
wherein the remote computer-based processing system is configured to:
classify the uploaded video file using a classifier to produce a confidence score indicating how confident the classifier is that motion in the uploaded video file is a particular type of motion;
wherein the first user computing device is configured to:
enable a first human user to specify a first threshold confidence score for receiving notifications about videos;
wherein the remote computer-based processing system is configured to send a notification of the uploaded video file if the confidence score associated with the uploaded video file meets or exceeds the user-specified first threshold confidence score for receiving notifications about videos,
wherein the notification, if sent, is accessible from the first user computing device.

20. The computer-based system of claim 19, wherein the first user computing device is further configured to enable the human user to specify the first threshold confidence score for receiving notifications about videos by:
presenting a graphical control element at a graphical user interface of the first user computing device,
wherein the graphical control element is configured to be manipulated by the human user so that the human user can thereby specify the first threshold confidence score for receiving notifications about videos.

21. The computer-based system of claim 20, wherein the graphical control element appears as a slider on the graphical user interface, and
wherein the human user can interact with the slider by moving an indicator and/or by touching or clicking on a point on the slider to set the first threshold confidence score for receiving notifications about videos.

22. The computer-based system of claim 19, wherein the particular type of motion is motion by a living being, and the confidence score indicates how confident the classifier is that the motion in the uploaded video file is motion by a living being.

23. The computer-based system of claim 19, wherein classifying the uploaded video file produces multiple confidence scores for the uploaded video file, wherein each of the multiple confidence scores indicates how confident the classifier is that any of the motion in the uploaded video file corresponds to each respective one of multiple different types of motion.

24. The computer-based system of claim 23, wherein each type of motion is a type of motion selected from the group consisting of: motion by a person, motion by a dog, motion by a cat, and motion by a non-living entity.

25. The computer-based system of claim 19, wherein the classifier comprises an artificial neural network for computer vision processing.

26. The computer-based system of claim 19, further comprising:
one or more second user computing devices coupled to the remote computer-based processing system via the network,
wherein each of the second user computing devices is configured to enable a second human user to specify a second threshold confidence score for receiving notifications about videos
wherein the remote computer-based processing system is configured to send a second notification of the uploaded video file if the confidence score associated with the uploaded video file meets or exceeds the user-specified second threshold confidence score for receiving notifications about videos, but not send the second notification if the confidence score associated with the uploaded video file does not meet or exceed the user-specified second threshold confidence score for receiving notifications about videos,
wherein the second notification, if sent, is accessible at least from a corresponding one of the second user computing devices.

27. A non-transitory, computer-readable medium that stores instructions executable by one or more processors to perform or facilitate the steps comprising:
uploading a video file from a monitoring device to a remote computer-based processing system;
classifying the uploaded video file using a classifier at the remote computer-based processing system that produces a confidence score indicating how confident the classifier is that motion in the uploaded video file corresponds to a particular class of motion;
enabling a first human user to specify, from a first user computing device, a first threshold confidence score for receiving notifications about videos;
sending a first notification of the uploaded video file if the confidence score associated with the uploaded video file meets or exceeds the user-specified first threshold confidence score for receiving notifications about videos,
wherein the first notification, if sent, is accessible at least from the first user computing device.

28. The non-transitory, computer-readable medium of claim 27 storing further instructions executable by one or more processors to perform or facilitate the steps comprising:
not sending the first notification if the confidence score associated with the uploaded video file does not meet or exceed the user-specified first threshold confidence score for receiving notifications about videos.

29. The non-transitory, computer-readable medium of claim 27, wherein enabling the first human user to specify the first threshold confidence score for receiving notifications about videos comprises:
presenting a graphical control element at a graphical user interface of the first user computing device, wherein the graphical control element is configured to be manipulated by the first human user so that the first human user can thereby specify the first threshold confidence score for receiving notifications about videos,
wherein the graphical control element appears as a slider on the graphical user interface, and
wherein the first human user can interact with the slider by moving an indicator and/or by touching or clicking on a point on the slider to set the first threshold confidence score for receiving notifications about videos.
